(19) United States
(12) Patent Application Publication
(10) Pub. No.: US 2020/0346234 A1
(43) Pub. Date: Nov. 5, 2020

(54) HARNESS FOR A PORTABLE LAWN/GARDEN FLUID SPRAYER

(71) Applicant: THE FOUNTAINHEAD GROUP, INC., NEW YORK MILLS, NY (US)

(72) Inventor: Matthew Merritt, Oneida, NY (US)

(73) Assignee: THE FOUNTAINHEAD GROUP, INC., NEW YORK MILLS, NY (US)

(21) Appl. No.: 16/964,096

(22) PCT Filed: Jan. 22, 2019
(86) PCT No.: PCT/US19/14527

§ 371 Date: Jul. 22, 2020

Related U.S. Application Data
(60) Provisional application No. 62/620,113, filed on Jan. 22, 2018.

(51) Int. Cl. B05B 9/08; A01M 7/00

(52) U.S. Cl. CPC B05B 9/0888; A01M 7/0046; B05B 9/0816

(57) ABSTRACT

A harness for a portable lawn/garden fluid sprayer having a tank and a spray hose is provided. The harness generally includes a first strap adapted to securely wrap around the tank adjacent the top thereof and having a first end and a second end that are interconnected by a first fastener that permits adjustment of the first strap; a second strap adapted to securely wrap around the tank adjacent the bottom thereof and having a first end and a second end that are interconnected by a second fastener that permits adjustment of the second strap; third and fourth straps that each tautly extend between the first and second straps and each having first ends that extend through a third fastener and fourth fastener, respectively, that permit the length of the third and fourth straps, and hence the distance separating the first and second straps, to be selectively adjusted; and first and second handles attached to the first strap.

### CROSS-REFERENCE TO RELATED APPLICATION

The present application relates and claims priority to U.S. Provisional Application No. 62/620,113, filed Jan. 22, 2018.

### FIELD OF THE INVENTION

The present disclosure is directed generally to portable lawn/garden compressed air fluid sprayers, and more particularly to accessories that assist in the handling of such sprayers.

### BACKGROUND

Portable lawn/garden and industrial/commercial compressed-air fluid sprayers and water supply tanks both utilize a pressure tank tor containing the fluid. Tanks are typically sized to contain fluid volumes of 1, 2, and 3 gallons. When full, a typical carry weight for the unit would be 11 pounds, 20 pounds, and 30 pounds respectively.

For portable lawn/garden sprayers, a carrying shoulder strap is often provided to assist the user to move with and operate the sprayer. When lifting and setting down the sprayer, the handle of the compressed-air pump, located at the top of the tank, is often specifically grasped for that purpose. However, when filling the tank with fluid the pump must be removed and so the tank is then held and manipulated by either its fill spout lip-feature or by its overall tank body.

For industrial/commercial water supply tanks, the unit is typically not carried during operation. When lifting and setting down the tank, the handle of the compressed-air pump, located at the top of the tank, is often grasped for that purpose. However, as with the lawn and garden sprayer, when filling the tank with fluid the pump must be removed and so the tank is then held and manipulated by either its fill spout lip-feature or by its overall tank body.

Accordingly, due to the shape, weight, and awkwardness of spray tanks, there is a need in the art for apparatus to assist in the handling of such portable sprayers.

It is therefore a principal object and advantage of the present invention to provide a harness strap system to assist in the lifting, manipulation, and operation of a portable compressed-air sprayer or water supply tank.

### SUMMARY

The present disclosure is directed to a harness for a portable lawn/garden fluid sprayer.

According to an aspect a harness for a portable lawn/garden fluid sprayer having a tank and a spray hose is provided. The harness generally comprises: a first strap adapted to securely wrap around the tank adjacent the top thereof and having a first end and a second end that are interconnected by a first fastener that permits adjustment of the first strap; a second strap adapted to securely wrap around the tank adjacent the bottom thereof and having a first end and a second end that are interconnected by a second fastener that permits adjustment of the second strap; third and fourth straps that each tautly extend between the first and second straps and each having first ends that extend through a third fastener and fourth fastener, respectively, that permit the length of the third and fourth straps, and hence the distance separating the first and second straps, to be selectively adjusted; and first and second handles attached to the first strap.

According to an embodiment, a fifth strap is provided that extends tautly between the first and second straps and is positioned in spaced parallel relationship to the third and fourth straps, and has a first end that extends through a fifth fattener that permits the length of the fifth strap, and hence the distance separating the first and second straps, to be selectively adjusted.

According to an embodiment, a sixth strap is provided that connects to and extends loosely from the first strap and includes a sixth fastener that permits the sixth strap to be wrapped around and securely contain the hose.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIGS. 1-3 are perspective views of prior art lawn/garden sprayers.

FIG. 4A-4C are perspective views of cylindrical prior art lawn/garden sprayers.

FIG. 5 is a perspective view of a harness attached to a lawn/garden sprayer, in accordance with an embodiment.

FIG. 6 is a front elevation view of a harness, in accordance with an embodiment.

FIG. 7 is a rear elevation view of a harness, in accordance with an embodiment.

FIG. 8 is a first side elevation view of a harness, in accordance with an embodiment.

FIG. 9 is a second side elevation view of a harness, in accordance with an embodiment.

FIG. 10 is a top plan view of a harness, in accordance with an embodiment.

FIG. 11 is a bottom plan view of a harness, in accordance with an embodiment.

FIG. 12 is a perspective view of a harness, in accordance with an embodiment.

FIG. 13 is a perspective view of a harness attached to a lawn/garden sprayer being held by a handle by a user, in accordance with an embodiment.

FIG. 14 is a perspective view of a harness attached to a lawn/garden sprayer with the hose passing through a tank stabilization feature, in accordance with an embodiment.

### DETAILED DESCRIPTION OF EMBODIMENTS

The present disclosure describes a harness for a portable lawn/garden sprayer. The harness assists in the handling of the portable lawn/garden sprayer.

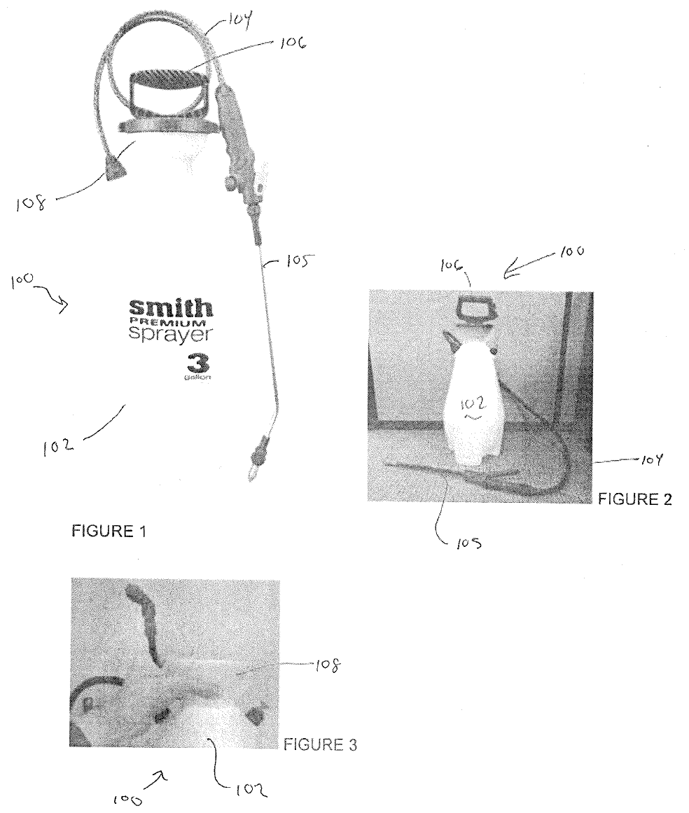

Referring to FIGS. 1-3, a lawn/garden sprayer 100 having a tank 102 and hose 104/wand 105 is shown. Sprayer 100 utilizes compressed air that is achieved by way of a manually operated pump/handle 106 positioned at the top of the tank 102. Sprayer 100 is carried by a user by pump/handle 106 and when needed to be filled and pump/handle 106 are removed, the user must manually manipulate the lip 108 at the top of the tank 102. This handling of sprayer 100 is awkward and prone to accidents as described more fully hereinafter.

With regard to FIG. 1, sprayer 100 is shown in its storage condition. In this condition, the hose 104 may be coiled, with the wand 105 held at the top by means of a provided hook feature. The hose 104 and wand 105 are obstructing access needed to both operate the pump and to remove the pump for filling the tank with fluid.

With regard to FIG. 2, sprayer 100 is shown with the hose 104 and wand 105 unhooked from the top of the pump 106. Note that with the wand 105 removed from its hook feature, access to the pump 106 is readily at hand. However, with the wand 105 unattached, it must either be held by hand or set down during operation or removal of the pump 106.

With regard to FIG. 3, sprayer 100 is shown with the hose 104 and wand 105 unhooked, and the pump 106 has been removed in order to fill the tank 102 with fluid. Note that in order to manipulate the tank 102, it is held by its fill-spout lip 108. Here, the wand 105 is also held simultaneously in order to protect the wand nozzle from ground contamination.

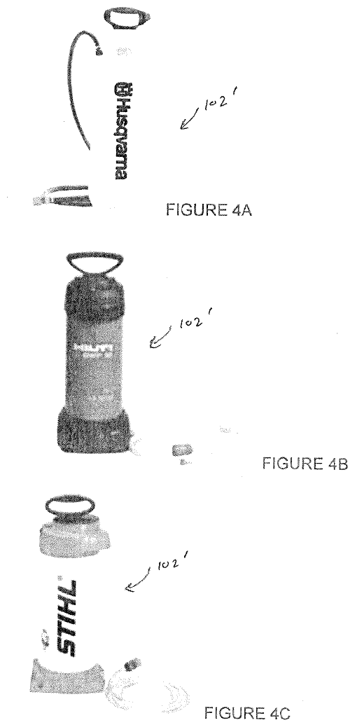

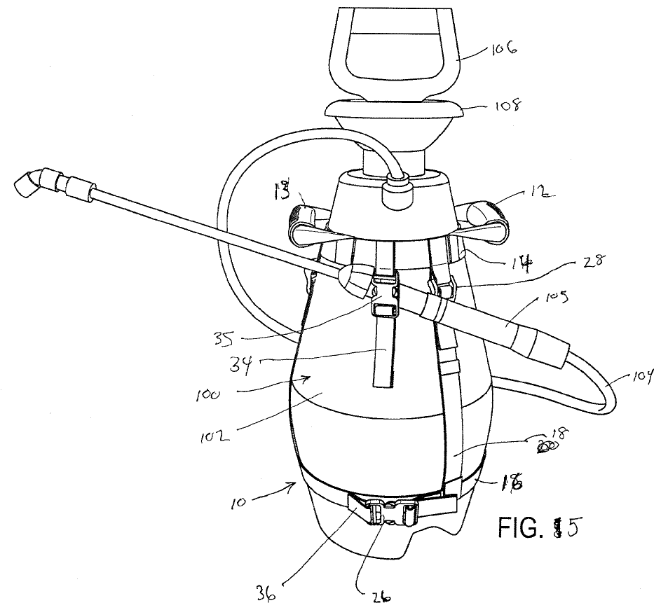

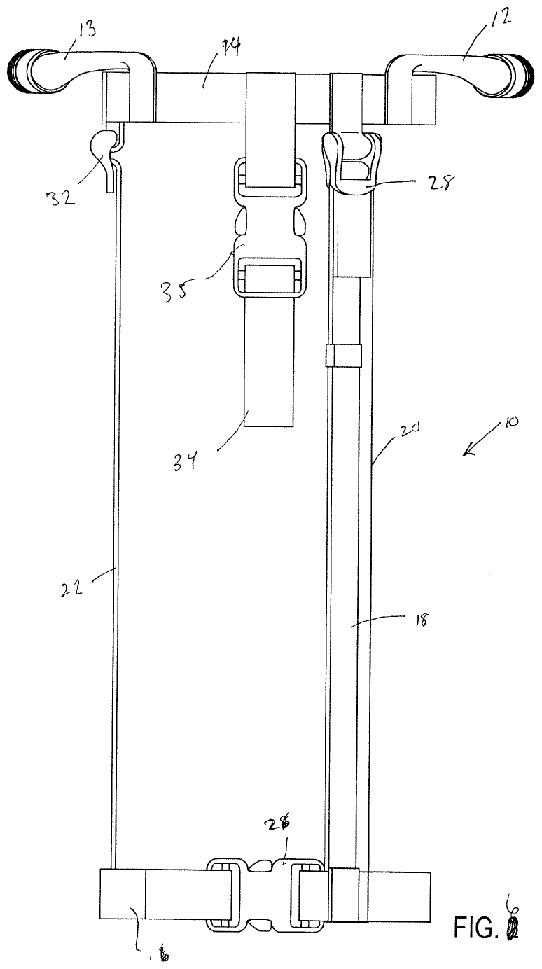

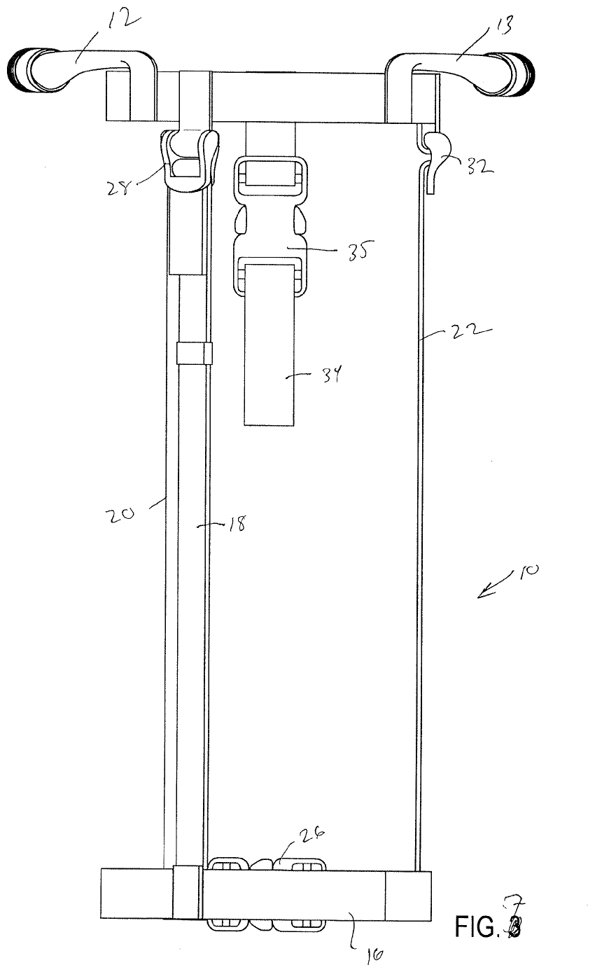

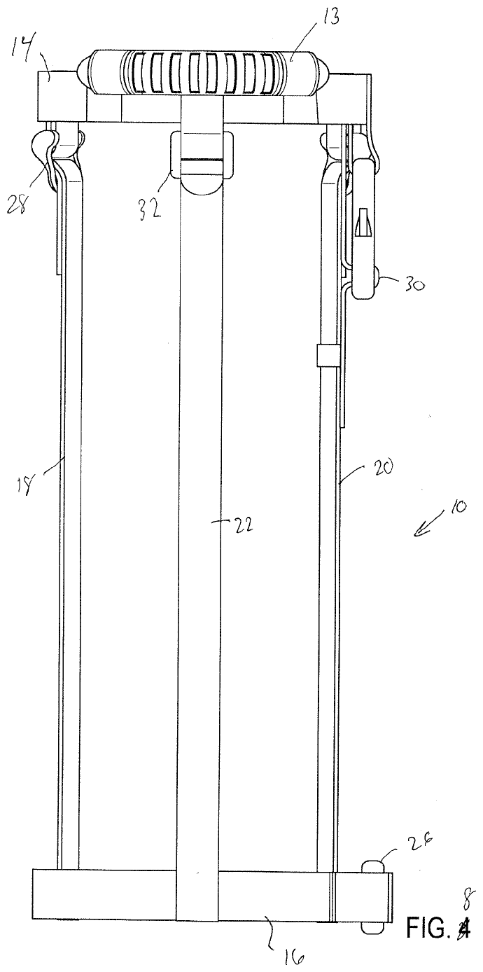

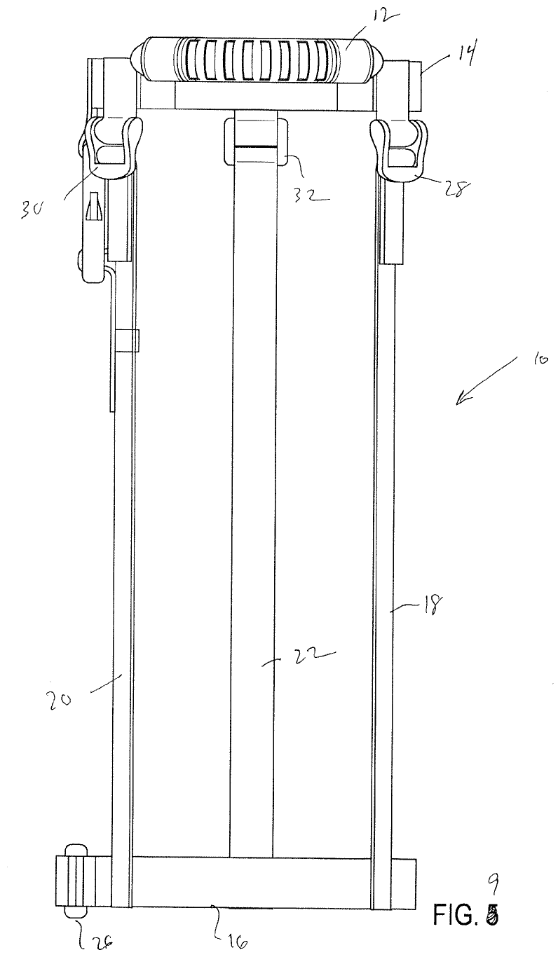

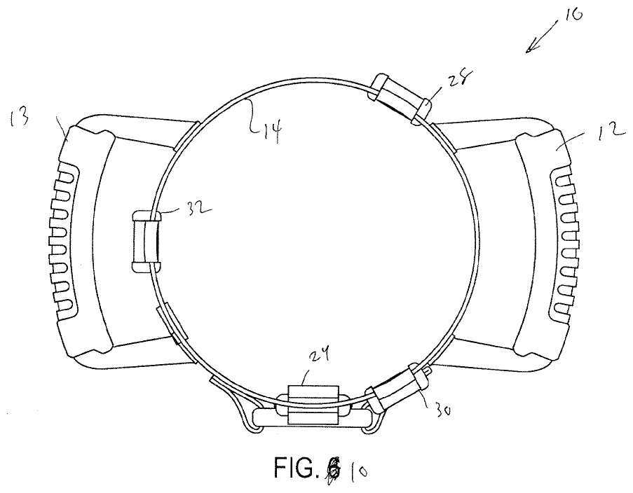

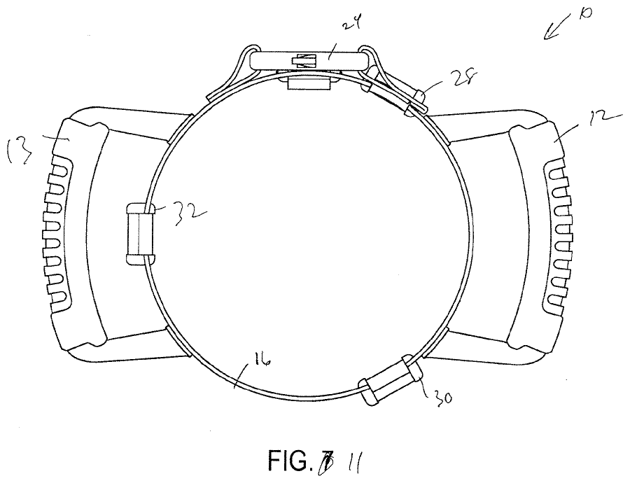

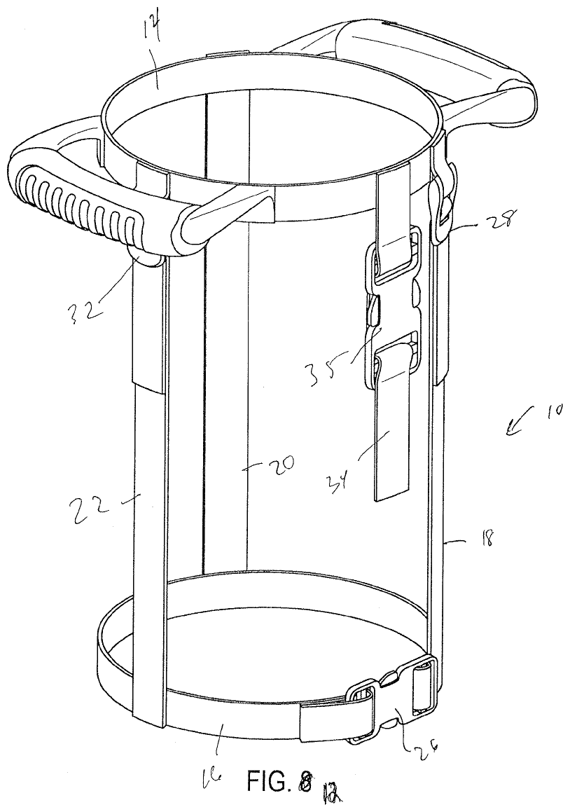

Referring now to FIGS. 5-13, a harness, designated generally by reference numeral 10, is employed on a sprayer 100 to ease the handling of the sprayer. In this embodiment, the harness 10 is adjustably cinched with multiple straps around the bulbous shape of the tank 102. Alternatively, for a more cylindrically-shaped tank 102′ (see FIG. 4), a strap could wrap under the bottom. This harness 10 provides carry handles 12, 13 for lifting and manipulating the tank 102. Note that the carry handles 12, 13 enable ready access for the user to both operate the pump 106 and to remove the pump 106 in order to fill the tank 102. The harness 10 also provides a clasp for holding the wand 105 away from the pump 106 and tank fill spout 108 and off the ground as well. This clasp can position the wand 105 in either a horizontal (as shown) or vertical orientation.

More specifically, harness 10 comprises first a second straps 14, 16, respectively, that are adapted to wrap around tank 102 adjacent the top and bottom thereof, respectively. The first and second straps are interconnected by a series of three straps 18, 20, and 22 (although as few as one could be used, and certainly more than three could be used as well) that extend in spaced parallel relation to one another and extend tautly between the first and second straps 14, 16. Each of straps 14, 16, 18, 20, and 22 are adjustable by passing one of their ends through a fastener, such as a buckle, 24, 26, 28, 30, and 32, respectively. It should be noted that fasteners, such as VELCRO®, snaps, ratchets, or other known systems could also be employed. The selective adjustment of the straps permits them to be used on tanks of various sizes and shapes. Handles 12 and 13 are attached to first strap 14 such that they extend from opposite sides of the sprayer 100. A final strap 34 is attached to and extends from first strap 14 and is adjustable via fastener 35. Strap 34 is used to wrap around the hose 104 or wand 105 and hold it in place off the ground.

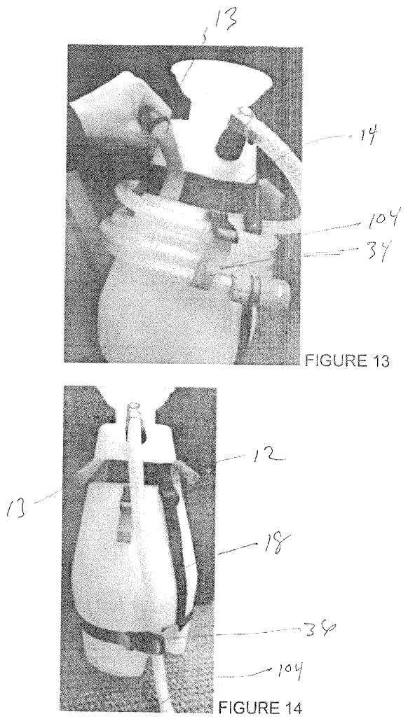

FIG. 13 shows a user holding and manipulating the tank 102 by grasping one of the two carry handles 12, 13 provided with the proposed harness 10. With the pump 106 removed for filling with water, the tank 102 may be readily carried and manipulated by the user.

FIG. 14 shows an in-use tank stabilization feature provided by the harness 10. This feature provides a clasp 36 that secures the hose 104 to the bottom of the tank 102, which lowers its pull-point with respect to the tank 102. If the hose 104 is inadvertently pulled during use, the tank 102 with this feature is more stable and is less likely to tip over. This feature may also be applied to the harness 10 for portable lawn/garden compressed-air fluid sprayers 100.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

1. A harness for a portable lawn/garden fluid sprayer having a tank and a spray hose, comprising:
a. a first strap adapted to securely wrap around the tank adjacent the top thereof and having a first end and a second end that are interconnected by a first fastener that permits adjustment of said first strap;
b. a second strap adapted to securely wrap around the tank adjacent the bottom thereof and having a first end and a second end that are interconnected by a second fastener that permits adjustment of said second strap;
c. third and fourth straps that each tautly extend between said first and second straps and each have first end that extends through a third fastener and fourth fastener, respectively, that permit the length of said third and fourth straps and hence the distance separating the first and second straps to be selectively adjusted; and
d. first and second handles attached to said first strap.

2. The harness according to claim 1, further comprising a fifth strap that extends tautly between said first and second straps and is positioned in spaced parallel relationship to said third and fourth straps, and has a first end that extends through a fifth fastener that permits the length of said fifth strap and hence the distance separating the first and second straps to be selectively adjusted.

3. The harness according to claim 1, further comprising a sixth strap that connects to and extends loosely from said first strap and includes a sixth fastener that permits the sixth strap to be wrapped around and securely contain the hose.
